(19) United States
(12) Patent Application Publication
(10) Pub. No.: US 2012/0241017 A1
(43) Pub. Date: Sep. 27, 2012

(54) Microfluidic Check Valves With Enhanced Cracking Pressures and Methods of Making the Same

(76) Inventors: Jeffrey Chun-Hui Lin, Pasadena, CA (US); Feiqiao Yu, Stanford, CA (US); Yu-Chong Tai, Pasadena, CA (US)

(21) Appl. No.: 13/427,282

(22) Filed: Mar. 22, 2012

Related U.S. Application Data
(60) Provisional application No. 61/466,132, filed on Mar. 22, 2011.

(51) Int. Cl. F16K 21/04; F16K 51/00

(52) U.S. Cl. 137/15.18; 137/511

(57) ABSTRACT

Microfluidic normally closed check valves and methods of making and using the same are provided. The check valves include an orifice, an occluding portion, and one or more attachment members which urge the occluding portion into a position occluding the orifice. In various embodiments, the attachment member or members are pre-stressed by thermal annealing to introduce tensile stress of at least 800 PSI therewithin, thereby increasing the cracking pressure of the valve

### CROSS-REFERENCE TO RELATED APPLICATION

This application claims priority to U.S. Provisional Application No. 61/466,132 by Lin et al. filed Mar. 22, 2011, the entire disclosure of which is hereby incorporated by reference for all purposes.

### TECHNICAL FIELD

The invention relates to valves for use in microfluidic systems. More particularly, the invention relates to a microfluidic check valve having a relatively high cracking pressure.

### BACKGROUND

Microfluidic systems—systems for manipulating very small volumes of fluids—rely on valves to, among other things, permit the control of flow direction, flow rate and pressure distribution. Check valves are one-way valves; they open to permit flows in one direction (the “preferred direction”) but prevent flows in the opposite direction. A normally-closed (NC) check valve is specifically designed to open in response to a fluid pressure above a certain threshold (referred to as the “cracking pressure”) in the preferred direction and to remain closed below that threshold. An NC check valve typically includes at least an input orifice, an occluding structure for blocking the input orifice and suitable means for urging the blocking structure into position to block the orifice.

There is a constant need in the microfluidics art for systems and methods of controlling the cracking pressures of NC check valves while minimizing their size and the complexity and the expense of manufacturing them. A typical strategy for controlling NC check valve cracking pressure is to select materials for the check valve based on their flexibility, as reflected by their Young's modulus. For instance, if high cracking pressure is desired, a material with large Young's modulus is used to provide the required pre-stressed force. This strategy may be of limited value, however, in cases where an application demands use of a flexible material but the NC check valve must nonetheless exhibit a high cracking pressure. For instance, a flexible biocompatible material such as parylene C (poly-chloro-para-xylene) with a Young's modulus of around 2.8-4 GPa (approximately 20 times more flexible than aluminum) may be required or strongly favored for systems that handle cells or biological fluids. If it is important to utilize a flexible material in a microfluidic system, high cracking pressures will be difficult to achieve because of the material's low Young's modulus. Accordingly, there is a need for microfluidic check valves that exhibit relatively high cracking pressures yet are formed from flexible materials.

### SUMMARY OF THE INVENTION

Embodiments of the current invention reconcile these opposing requirements by imparting residual tensile stress into one or more critical elements of a check valve. Systems and methods of the invention can accordingly be employed to make NC check valves with high cracking pressures and small form factors so as to be compatible with a wide range of microfluidic applications, and to accommodate the need for biocompatibility.

In one aspect, the invention relates to a microfluidic check valve. In various embodiments, the valve includes a base with an orifice, and a sealing member. The sealing member, in these embodiments, includes an occluding portion sized to occlude the orifice and one or more attachment member(s) to urge the occluding portion into a closed position, which attachment member(s) consist essentially of a thermally annealed polymer. In some embodiments, the attachment member(s) include one or more tethers which may, for example, be disposed radially about a central occluding portion. In some embodiments, the sealing member is made of parylene, while more generally the sealing member may be made of any substance having a Young's modulus less than 5 GPa. A tensile stress on the attachment member(s) may be between 1200 and 2600 PSI in some embodiments, and the attachment member(s) may be less than 100 μm wide, less than 5 μm thick, and/or angled away from the base.

In another aspect, the invention relates to a method of forming a microfluidic check valve. In various embodiments, the method includes the steps of providing a sealing member with an occluding portion and at least one attachment member to urge the occluding portion into a closed position, and thermally annealing the at least one attachment member to increase a tensile stress of the attachment member to at least 800 PSI. In some embodiments, the method includes increasing the tensile stress of the attachment member to between 1200 and 2600 PSI. The sealing member may, in various embodiments, be made of parylene, while the attachment member may comprise one or more tethers disposed radially about the occluding portion.

In yet another aspect, the invention relates to a method of forming a microfluidic check valve. In various embodiments, the method includes the steps of providing a refractory base, forming a generally frustoconical photoresist layer on the base, applying a parylene coating to the base, stripping the photoresist layer and thermally annealing at least a portion of the parylene coating to increase a tensile stress therewithin. In some embodiments, the step of forming the photoresist layer includes developing the photoresist layer using a grayscale photomask that has a non-linear UV light transmittance across a cross sectional dimension.

### DRAWINGS

In the drawings, like reference characters refer to like features through the different views. The drawings are not necessarily to scale, with emphasis being placed on illustration of the principles of the invention.

FIG. 1 is a sectional view of a check valve with thermally pre-stressed tensile tethers after thermal annealing in accordance with some embodiments of the invention.

FIG. 2 depicts a gray-scale photomask for the creation of a slanted photoresist, and an enlarged view showing a closer view of a part of the pixel structure of the ring.

FIGS. 3A and 3B graphically illustrate, respectively, gray-scale photoresist profiles before linearization and after linearization.

FIG. 4 illustrates a representative fabrication sequence for check valves having an angled attachment member.

FIG. 5 schematically illustrates a testing arrangement used to test: (a) check valves on a die, and (b) a single check valve packaged in a capillary tube.

FIGS. 6A and 6B graphically illustrate the effect on cracking pressure of, respectively, different tether widths but the same annealing temperature at 100° C., and the same tether width (50 μm) but different annealing temperatures.

FIG. 7 is a sectional view of a check valve including an anchor portion extending into a trench within the base in accordance with some embodiments of the invention.

FIG. 8 is a sectional view of a pressure testing jig for one or more valves on a die in accordance with some embodiments of the invention.

FIG. 9 is a sectional view of a capillary tube adaptor for cracking pressure measurement in accordance with some embodiments of the invention.

### DETAILED DESCRIPTION

### Cracking-Pressure Controlled Check Valves:

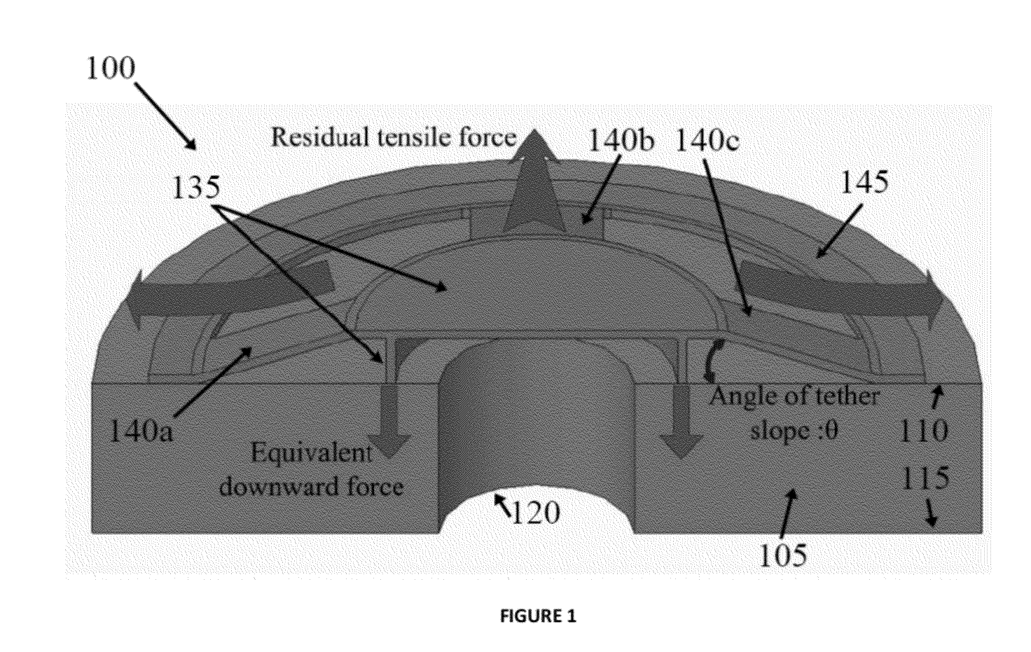

An exemplary configuration of a cracking-pressure controlled check valve with thermally pre-stressed tethers is shown in FIG. 1. The check valve 100 includes a base 105 having front and back surfaces 110, 115 and an orifice 120 therethrough. A sealing member 130, which includes an occluding portion 135 sized to seal the orifice 120, overlies the front surface 110 of the silicon base. An attachment member 140 connects the occluding portion 135 to an anchor 145, which is itself bonded or otherwise anchored to the base 105. In the illustrated embodiment 100, the attachment member 140 is a plurality of radially distributed tethers, three of which are indicated at 140a, 140b, 140c. In general, the tethers 140 are equidistant radially, so that the illustrated configuration would include a fourth tether (not shown). As explained below, however, any suitable number of tethers may be utilized for a particular application. Moreover, in some implementations, the attachment member is anchored directly to the base 105.

In use, fluid enters the valve 100 through the orifice 120 and exerts pressure on the occluding portion 135. As long as the fluid pressure exerted on the occluding portion 135 is less than the cracking pressure, the valve remains closed and fluid does not flow through. However, once the fluid pressure exerted through the orifice 120 on the occluding portion 135 exceeds the cracking pressure, the occluding portion is forced away from the orifice, permitting fluid to flow through until the pressure exerted through the orifice once again falls below the cracking pressure, at which point the occluding portion 135 returns to its closed position sealing the orifice 120.

The base 105 may be any suitably rigid material but is desirably chosen based on cost and compatibility with conveniently practiced fabrication techniques. For example, silicon is well-suited to conventional techniques of microfabrication, such as those involving depositing layers of material and patterning them (e.g., by acid etching or photolithograpically, as discussed in more detail below).

The sealing member 130 is preferably made of parylene or another material having a low Young's modulus. The exemplary embodiments described herein focus on the use of parylene, which herein denotes para-xylene polymers generally, though in preferred embodiments sealing member 130 is made of Parylene C chlorinated para-xylene polymers. However, any other suitable flexible material may be used to form sealing member 130; for instance a differently halogenated parylene such as Parylene D, Parylene-HT and the like, or another polymer having similar physical characteristics, such as such as polypropylene (PP, Young's modulus=1.5-2 GPa), polyethylene terephthalate (PET, Young's modulus=2-2.7 GPa), polystyrene (PS, Young's modulus=3-3.5 GPa), Nylon (Young's modulus=2-4 GPa), silicone, polydimethylsiloxane (PDMS), and the like. The flexible material is chosen in some embodiments for physical characteristics that are well suited to particular applications, such as biocompatibility and/or a Young's modulus below 10 GPa, below 5 GPa, or below 3 GPa. In general, in applications where cracking pressure less than 10 PSI is desired, a material with a Young's modulus less than 4 GPa may be preferred, while materials having Young's moduli above 4 GPa may be preferred in applications in which the desired cracking pressure is above 10 PSI.

In various embodiments, attachment member 140 comprises a plurality of tethers arranged radially about the occluding portion 135, so that the sealing force applied by the attachment member is applied only in a direction perpendicular to the front surface 110 of the silicon base 105 and the orifice 120. In these embodiments, anchor 145 is disposed circumferentially around the attachment member 140. However, other suitable arrangements are possible; for example, the occluding portion 135 may be secured by a hinge to the base 105 and a single attachment member 140 may be disposed opposite the hinge. Alternatively, attachment 140 may take the form of webbing rather than discrete tethers. Anchor 145 may be continuous, forming a ring or other structure around the periphery of the sealing member 130 as shown in the drawings, or may be discontinuous. Still other arrangements will occur to those skilled in the art.

Any suitable number of tethers may be chosen to constitute attachment member 140, including without limitation 1, 2, 3, 4, 5, 6, 7, 8, 9 or 10 or more tethers. The tethers may be angled relative to the front surface 110 of the silicon base 105, and again, any suitable angle between, 0° and 90° may be used, including without limitation 0.1°, 5°, 10°, 15°, 30°, 45°, 60° or 89.9°. In general, tether angles between 30° and 60° are preferred for maximizing cracking pressure in embodiments of the invention when other variables are kept equal. In the illustrated embodiment 100, the tether angle is established by the height of the occluding portion 135, to which the tethers are joined, and the lengths of the tethers.

Additionally, the shape and area of the orifice 120 can be varied; though it is described throughout this disclosure as substantially round, the orifice 120 can have any suitable shape including square, oval, triangular, polygonal or irregular. Similarly, the overall dimensions of valve 100, for instance the extent of the longest cross-sectional axis of the entire valve (i.e., the outer diameter or its equivalent for non-round valves), can be selected for particular applications and/or desired cracking pressures.

Valve 100 can have any suitable cracking pressure, but will generally have a cracking pressure of less than 10 pounds per square inch (PSI). In some embodiments, valve 100 advantageously provides a higher cracking pressure than the approximately 2.9 PSI achieved by parylene micro-check valves reported in the literature. (See e.g. P. J. Chen et al., “Surface-micromachined parylene dual valves for on-chip unpowered microflow regulation,” Journal of Microelectromechanical Systems, vol. 16, pp. 223-231, April 2007; see also X.-Q. Wang and Y.-C. Tai, “A normally closed in-channel micro check valve,” in Micro Electro Mechanical Systems, 2000. MEMS 2000. The Thirteenth Annual International Conference on Micro Electro Mechanical Systems 2000, pp. 68-73. Both of these references are hereby incorporated by reference for all purposes.) For the sake of illustration, a valve in accordance with the invention may have a cracking pressure of 0.1, 0.5, 1, 2, 3, 4, 5, 6, 7, 8, 9 or 10 or more PSI. The cracking pressure will generally increase with the number of tethers 140, the residual tensile stress which the tethers are under, and the widths and thicknesses of the tethers (when other variables are held roughly equal), while cracking pressure will generally decrease as the size of the occluding portion increases. Though the exemplary embodiments herein focus on roughly circular occluding portion geometries, the occluding portion may have any suitable shape that occludes the aperture within the base, including without limitation square, triangular, polygonal, or irregularly shaped.

The final cracking pressure of check valve 100 can be mathematically represented as

$$P \text{?} = \frac{t \times w \times n \times σ \text{?} \times sin θ}{n \times \text{?}} \\ \text{?} \text{indicates text missing or illegible when filed} \qquad ( 1 )$$

where P_{c} is the cracking pressure of check valve 100; t is the thickness of the parylene sealing member 130; w is the width of the tethers 140; n is the number of tethers 140; σᵢ is the residual tensile stress of the tethers 140; θ is the angle of the tether slope; and r is the radius of the occluding portion 135. Equation 1 demonstrates that cracking pressure can be controlled by several parameters such as tether geometry (including tether width and tether shape), tether thickness, the angle(s) at which the tethers are slanted, tether numbers, and the degree of tension to which the tethers are subjected. All of these parameters can be varied to produce valves having desired cracking pressures.

### Fabrication of Micro-Check Valves:

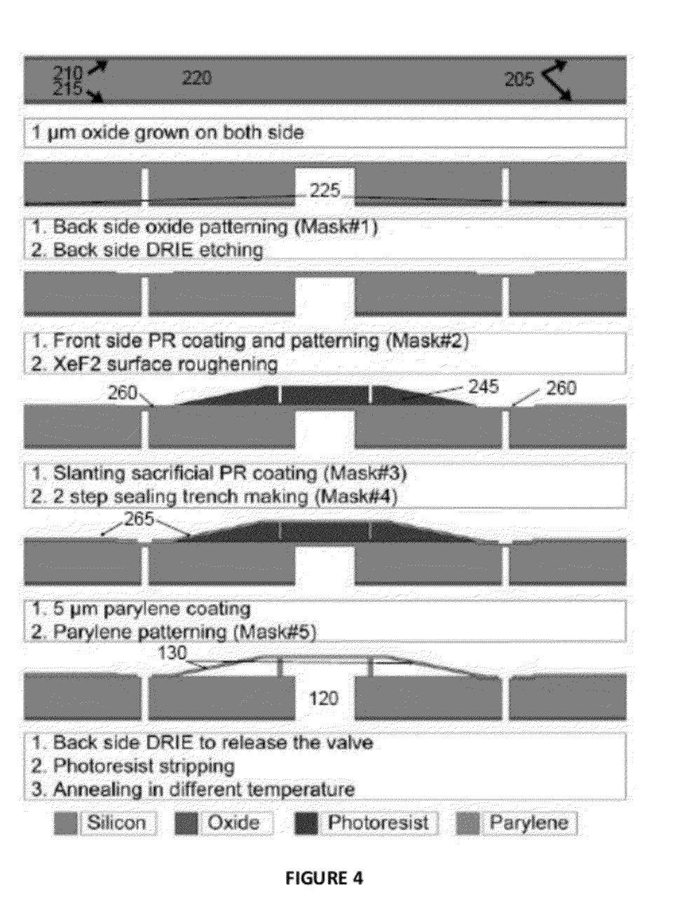

A representative fabrication sequence 200 is shown in FIG. 4. The sequence, excluding thermal annealing and other post-processing steps, includes or consists of

(1) Grow a layer 205 of thermal oxide on front and back sides 210, 215 of a double-sided polished silicon wafer 220.

(2) Transfer a pattern 225 on the back-side oxide using buffered hydrofluoric acid (BHF), and define and etch the profile of the back side 215 by deep etching, for example, deep reactive ion etching (DRIE) using a first photoresist mask 230.

(3) Roughen the surface of the front side 210 (for example, with xenon difluoride) using a second photoresist mask 235.

(4) Form a first photoresist layer 240 (for example, by spin coating) on the front-side silicon surface 210 and form a slanted photoresist 245 by partial exposure using a third gray-scale photomask 250 (described in more detail below). Using a fourth photomask 255, create a circular trench 260 for the anchor portion 145. Note that the exposure time used to create the circular trench 260 is less than the exposure time used to generate the sacrificial slanted photoresist 245.

(5) Deposit parylene C layer 265 and define check valve's profile using a fifth photoresist mask and oxygen plasma etching.

(6) Etch through back-side silicon surface 215 (for example, by DRIE) and strip photoresist layers 240, 245 (for example, by application of a solvent such as acetone and/or other solvent).

These steps can be modified, as will be evident to one skilled in the art. For example, though the front-side surface is roughened by xenon difluoride in the exemplary process flow above in order to facilitate anchoring of the flexible sealing member 130 to the base 105, other suitable means of surface roughening and/or anchoring—such as mushroom-type trench anchoring, laser annealing bonding, temperature assisted bonding, and the like—can be employed to facilitate the anchoring of the flexible sealing member to the base. Additionally, parylene deposition and patterning can be performed on the front side 210 of the wafer before or after patterning the back side 215 of the wafer 220. The orifice 120 may be etched away at any suitable time during fabrication or annealing, for example as the last step before valve release, and the check valve 100 can be released from the wafer 220 prior to post-processing an annealing, or it can remain on the wafer 220 during post processing.

In some embodiments, a slanted sacrificial photoresist 245 is not used, and another suitable slanted substrate layer is used to form the slanted attachment member 140. For example, a substantially frustoconical silicon surface may be obtained by anisotropic wet etching using a suitable etchant such as potassium hydroxide (KOH) or tetramethylammonium hydroxide (TMAH). The frustoconical silicon surface can subsequently be removed using any suitable method such as wet or dry silicon bulk etching.

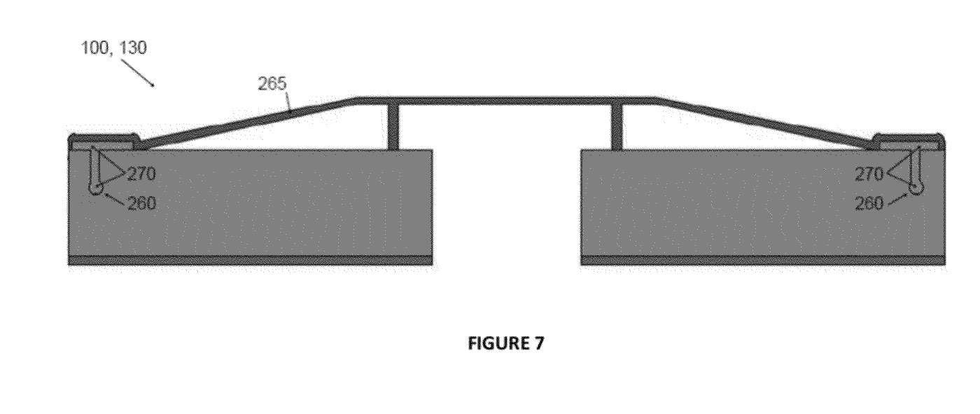

If desired, additional polymer layers, such as polydimethylsiloxane (PDMS) layers can be deposited above or below a parylene layer to form a multi-layered sealing member 130. This may be useful, for example to form anchors comprising multiple polymers, as is shown in FIG. 7. A first polymer layer 270 is deposited and patterned to fill in the circular trench 260 prior to deposition of the parylene-C layer 265. Parylene-C layer 265 may be deposited using any suitable method under any suitable conditions currently known in the art. In an exemplary deposition process, parylene-C is evaporated in an evaporator at 180° C., undergoes pyrolysis at 690° C., and is deposited in a room temperature (20° C.) chamber at 22 mT. Following deposition, the Parylene-C layer 265 can be under compressive stress, as discussed in more detail below.

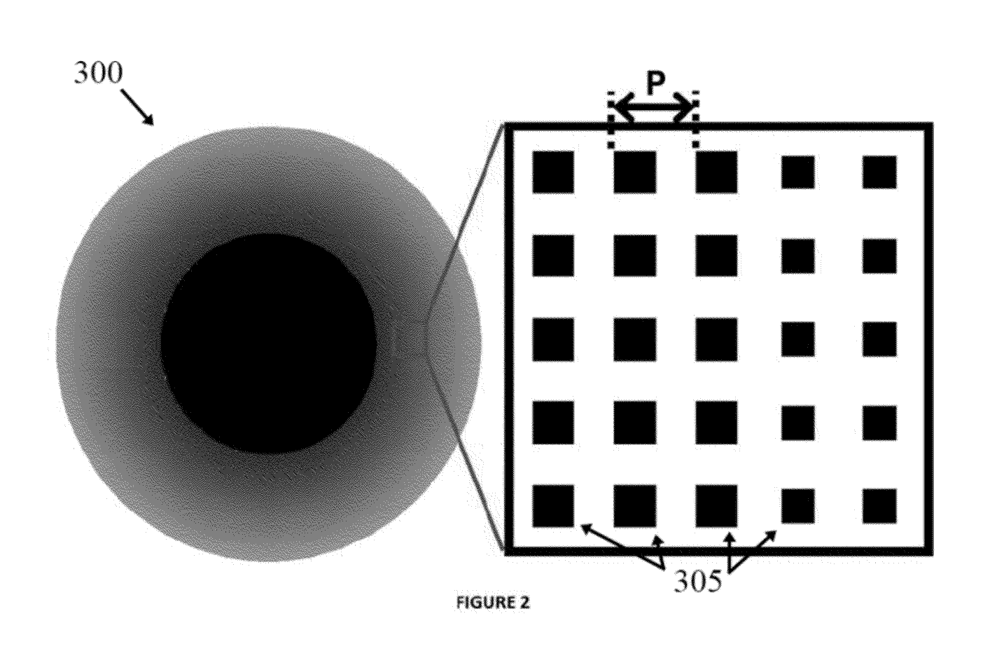

In order to fabricate slanted valve elements such as attachment members with multiple parylene tethers, a gray-scale photomask technique may be used in the lithography process to make the slanted sacrificial photoresist layer 245 in a manner similar to that described in Y. Oppliger et al, “One-step 3D Shaping Using a Gray-Tone Mask for Optical and Microelectronic Applications,” Microelectronic Engineering, 23, pp. 449-454, 1994, which is hereby incorporated by reference. A grayscale photomask 300 for forming a slanted photoresist layer 245 is shown in FIG. 2. An array of small dark squares 305 with pitch, p, smaller than the diffraction limit of the ultraviolet (UV) exposure system, p_{c}, are designed on the photomask 300. When pitch, p, is smaller than the diffraction limit, dark squares 305 permit transmission of zero-order diffracted light but block first- and higher-order diffracted light, such that the light transmittance of the photomask is inversely proportional to the coverage area of the dark squares 305.

The pitch, p, is selected according to the numerical aperture and the diffraction limit. In general, a smaller pitch is used in systems with a lower diffraction limit. The maximum allowed square pitch size, p, can be expressed as

$$p \leq {p}_{c} = \frac{1}{1 + σ} \times \frac{λ}{N A} , \qquad ( 2 )$$

where σ is the coherence factor of the optical system, λ is the UV wavelength and NA is the numerical aperture of the exposure system. Given a stepper with 10:1 optical image reduction, the pitch of dark squares 305 can be designed so as not to exceed about 10 μm on photomask 300.

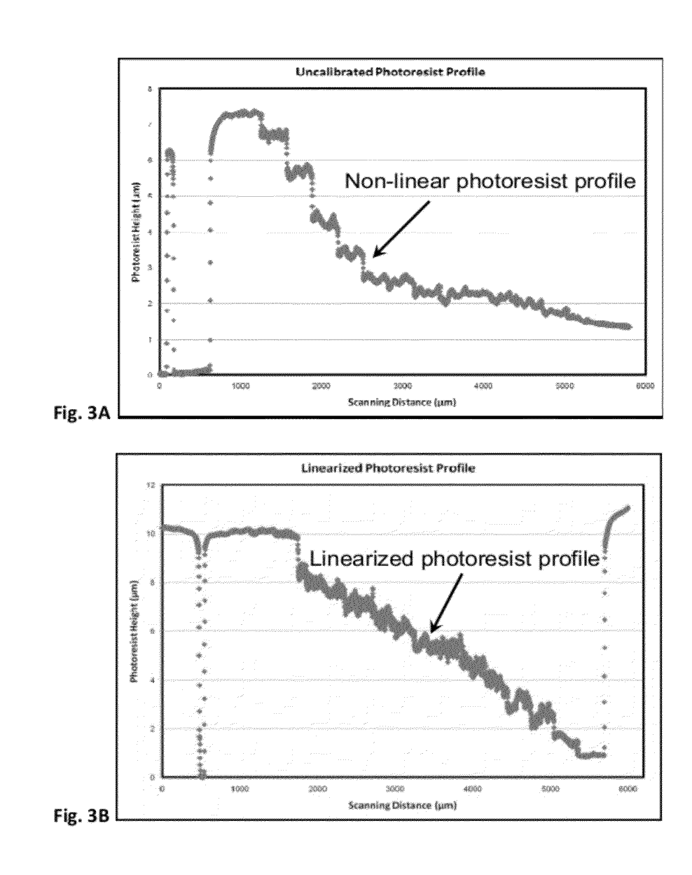

In preferred embodiments, the attachment member 140 is slanted rather than curved, so the profile of the slanted sacrificial photoresist 245 is also preferably linear rather than curved or stepped. Most photoresist layers have a nonlinear response to UV light exposure; therefore, a gray-scale photomask pattern with linear transmittance distribution will yield a nonlinear photoresist profile, as shown in FIG. 3A. To make the slanted photoresist linear, a mathematical model is used to characterize and linearize the final photoresist profile in a manner similar to that disclosed in M. LeCompte et al., “Photoresist Characterization and Linearization Procedure for The Gray-Scale Fabrication of Diffractive Optical Elements,” Appl. Opt., Vol. 40, No. 32, pp. 5921-5927, 2001, which is incorporated by reference herein in its entirety. In the model, the original total percentage of unexposed photoresist is normalized as 1, and the percentage of exposed photoresist is denoted as E(t), which is generated after exposure to UV light within a period of time, t. E(t) can be expressed as

E(t)=1−exp(−αI₀Tt) (3)

where α is the constant of proportionality, I₀ is the exposure light intensity and T is the transmittance of the photomasks. Therefore, to have a linear distribution of unexposed photoresist, 1-E(t), Eq. (3) can be used to determine the corresponding transmittance distribution on photomask. FIG. 3B shows the scanning result of the characterized and linearized photoresist profile. In an exemplary embodiment, to yield a valve having tethers with a tether angle θ of approximately 1.72 degrees, a slanted photoresist with a slope of approximately 1.72 degrees is formed using a grayscale mask having multiple transmittance steps. The number transmittance steps within the grayscale mask is selected based on the desired tether length as well as the computation capability of the computer. For example, more steps may be used in applications where a longer tether length is desired, or in which greater computing power is available. In an exemplary embodiment summarized in Table 1, below, 16 transmittance steps are used to achieve a substantially linear sloped photoresist layer.

TABLE 1
Square dimensions of an Exemplary 16-transmittance-
step photoresist:
Square Dimensions for an Exemplary Grayscale Mask
Having 16 Transmittance Steps in Square Size and a
2.5 μm Pitch (μm)

```
Center: Totally blocked
  1^{st}: 2.4 × 2.4
  2^{nd}: 2.37 × 2.37
  3^{rd}: 2.33 × 2.33
  4^{th}: 2.29 × 2.29
  5^{th}: 2.25 × 2.25
  6^{th}: 2.21 × 2.21
  7^{th}: 2.17 × 2.17
  8^{th}: 2.11 × 2.11
  9^{th}: 2.03 × 2.03
10^{th}: 1.97 × 1.97
11^{th}: 1.89 × 1.89
12^{th}: 1.79 × 1.79
13^{th}: 1.64 × 1.64
14^{th}: 1.48 × 1.48
15^{th}: 1.22 × 1.22
16^{th}: 0.79 × 0.79
```

### Thermal Annealing:

In some embodiments, following check valve fabrication, the valve 100 subjected to thermal annealing. The term “thermal annealing” or the shorthand “annealing” refers to the process of exposing a material to a selected temperature (the “annealing temperature”) and then cooled (“quenched”) to a lower temperature (the “quenching temperature”) so as to alter the residual tensile stress within the tethers 140. In general, temperature-sensitive materials such as parylene-C exhibit different physical properties before and after thermal annealing. For example, the Young's modulus and/or the glass transition temperature of a temperature-sensitive material may be different before and after thermal annealing, and the type and degree of stress the material is under may change as well.

During the annealing process, stress within the sealing member 130 is relaxed by heating, and then, as the valve 100 cools, tensile stress re-accumulates in the tethers 140, urging the occluding portion 135 into contact with the base 105 and thereby sealing the silicon orifice. This tensile stress results because of the high thermal expansion coefficient of parylene compared to relatively lower thermal expansion coefficient of the silicon base substrate, as is explained in S. Dabral, et al. “Stress in Thermally Annealed Parylene Films,” J. Electron. Mater., Vol. 21, No. 10, pp. 989-994, 1992, which is incorporated herein by reference for all purposes. In an exemplary fabrication sequence, the stress on a sealing member 130 comprising parylene C can change as follows:

1) Following deposition, the parylene layer is under compressive stress of approximately 870 PSI.

2) The check valve 100 is patterned and the sealing member 130 is formed, placing the tethers 140 under tensile stress of approximately 1121 PSI. (Note that valve 100 is exposed to temperatures up to approximately 100° C. during patterning.)

3) During annealing, the sealing member 130 fully relaxes—i.e. stress on the sealing member 130 is 0 PSI—while the valve 100 is held at approximately 140° C. under vacuum to prevent oxidation.

4) The check valve 100 is rapidly quenched to room temperature (˜20° C.) following annealing, and thereafter the tethers 140 are subject to tensile stress of approximately 1681 PSI.

The annealing temperature is below the melting temperature of the sealing member 130 (in the case of parylene C, below 290° C.). The valve 100 is held at the annealing temperature for an interval (the “annealing time”) that is selected based on the annealing temperature and the residual stress accumulated in the sealing member 130 during fabrication. Annealing times of two hours or less are suitable for most applications. In some embodiments, annealing is performed under vacuum to minimize contact between the heated sealing member 130 and materials that may oxidize it, such as atmospheric oxygen.

Thermal annealing includes a quenching step, which is performed by cooling of valve 100 from the annealing temperature to a selected quenching temperature such as room temperature. In some embodiments, quenching time—the time required for the valve to cool from the annealing temperature to the quenching temperature—is minimized by contacting a thermally annealed valve 100 with a high heat capacity material chilled to the quenching temperature. For example, in some embodiments, a die including multiple valves 100 is removed from the vacuum oven following annealing and placed on a metal plate held at the quenching temperature.

The quenching time can be selected based on the level of residual stress in the sealing member 130 that is desired. Extended quenching times, in which the valve 100 cools gradually from the annealing temperature to the quenching temperature, will generally result in lower or even zero residual stress, while shorter quenching times will generally result in higher residual stress. The choice of quenching temperature and time is influenced by the annealing temperature, as higher annealing temperatures result in higher rates of stress relaxation during quenching. In some embodiments, the quenching time is extended so that essentially no residual stress is added to the sealing member 130, resulting in a cracking pressure of approximately zero.

In some embodiments, the thermal annealing step includes annealing for 30 minutes at 100° C. for 30 minutes and results in an increase in the Young's modulus from a pre-annealing value of approximately 2.7 GPa to a post-annealing value of approximately 4 GPa. In some embodiments, the annealing temperature is greater than the glass transition temperature of the material in the sealing member 130. For example, the glass transition temperature of parylene-C when deposited is 50° C., so the annealing temperature for valves including a parylene sealing member 130 is above 50° C.

The glass transition temperature of the sealing member 130 can also be tailored to specific applications by thermal annealing. The glass transition temperature of parylene C increases from a pre-annealing value of 50° C. to approximately 100° C. following annealing at 100° C. for as little as 5 minutes. In general tensile stress within a material tends to relax more rapidly at temperatures approaching the glass transition temperature, while relaxation is much slower at lower temperatures. To preserve a high level of residual tensile stress within the sealing member 130, the valve 100 is preferably operated at a temperature substantially below the glass transition temperature of the material(s) comprising the sealing member 130. The range of suitable operating temperatures can be advantageously increased by thermally annealing at least a portion of the sealing member 130 to increase the glass transition temperature thereof. In an exemplary embodiment, a valve 100 that is intended for use with living biological Materials at 37° C. undergoes thermal annealing to increase the glass transition temperature thereof prior to use.

Since the residual thermal tensile stress of parylene can be as high as 34 MPa at 250° C., the equivalent cracking pressure generated can reach several PSI. This allows the slanted tethers 140 to provide a high equivalent downward force without the need for any post-fabrication fixation. Table 2, below, lists exemplary residual tensile stresses on tethers in exemplary valves having selected cracking pressures. In the exemplary valves, the tether angle θ is approximately 1.72 degrees, such that sin(θ) is 0.03, the tether width is 100 μm, the parylene thickness is 10 μm, the radius of the occluding portion 135 is 100 μm and the valve includes 4 tethers.

TABLE 2
Representative Tensile Stresses on Tethers of Exemplary Valves:

| Cracking pressure | Tensile stress on |
|---|---|
| (psi) | Tethers (psi) |
| 0.1 | 26.18 |
| 0.5 | 130.5 |
| 1 | 261.8 |
| 3 | 785.9 |
| 5 | 1305 |
| 10 | 2617 |

It will be appreciated that the relationship between cracking pressure and tensile stress, when other variables are held constant, is substantially linear in accordance with Eq. 1 above for tensile stresses below the tensile strength of the material or materials comprising sealing member 130.

As discussed above and as set forth in Eq. 1, the cracking pressure of valve 100 depends on the residual tensile stress, σᵢ, of its tethers 140, which can be represented as

[symbol]

Here, E is the Young's modulus (for parylene-C, 2.76 GPa); a is the thermal expansion coefficient of the material comprising the sealing member 130 (again, for parylene-C, 35 ppm); ΔT is the temperature difference between the annealing temperature and the quenching temperature, e.g. room temperature (20° C.). In some embodiments, the annealing temperature is selected based on the desired the cracking pressure and the geometry of the valve 100, including tether width, tether number, etc. using equations 1 and 4. Table 3, below, depicts annealing temperatures and cracking pressures for the exemplary valves of the invention as described above in connection with table 2, but having a tether width of 50 μm.

TABLE 3
Selected Annealing Temperatures and
Selected Cracking Pressures:

| Annealing | Cracking pressure |
|---|---|
| temperature (° C.) | (PSI) |
| 80 | 0.8 |
| 100 | 1.07 |
| 140 | 1.61 |
| 160 | 1.87 |
| 180 | 2.14 |
| 200 | 2.41 |

### Measurement of Cracking Pressure:

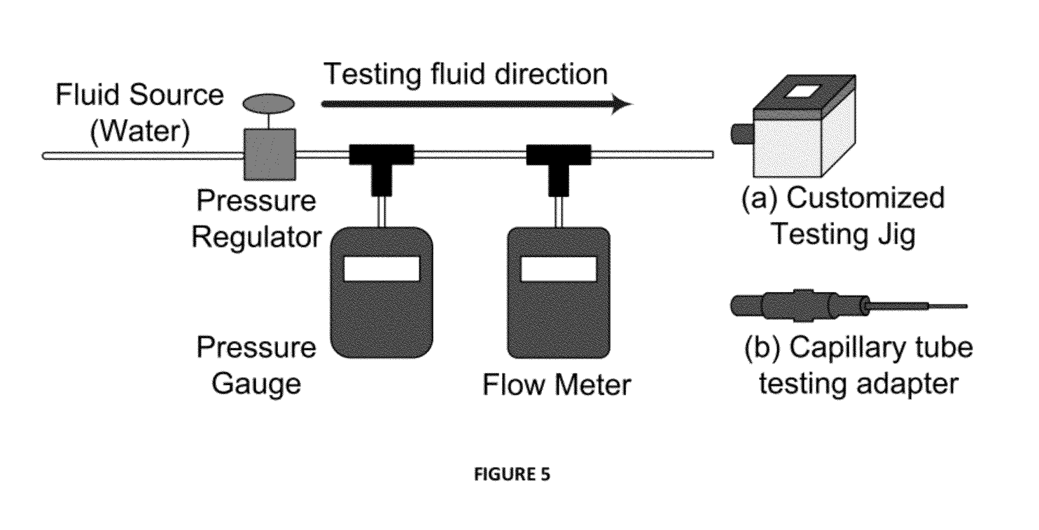

The cracking pressure of an NC check valve can be measured using an arrangement as shown in FIG. 5. A customized testing jig as indicated at (a) is used to test check valves on a die while a capillary tube testing adapter as shown at (b) is used to test single check valves that are packaged in a capillary tube following release.

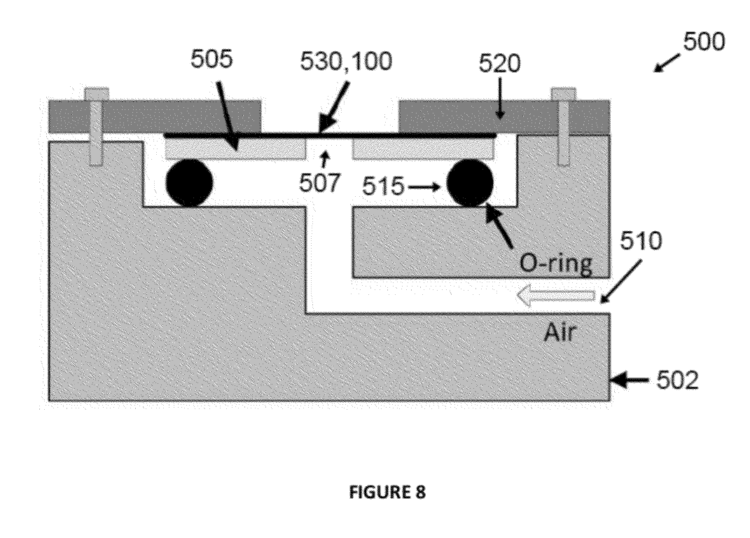

When multiple valves are fabricated on a single die, a customized testing jig as shown in FIG. 8 can be used to Query assess cracking pressure. Die testing jig 500 includes a base 502 and a rigid wafer 505 having an aperture 507 therethrough. A fluid supply 510 is positioned so as to deliver fluid to the aperture 507. Rigid wafer 505 rests on an elastic o-ring 515 which, in turn, rests on the base 502. At least one clamp 520 overlies the rigid wafer 505 and is positioned to permit insertion of a die 530 including multiple check valves 100, such that, when the clamp is engaged, downward force is applied about the circumference of the die 530 and the rigid wafer 505, compressing the elastic o-ring 515 and resulting in an airtight seal. The die 530 is positioned so that at least one valve 100 overlies the aperture 507. In use, air or another fluid is introduced through the fluid supply 510 at a selected pressure below the cracking pressure of the valves, and the pressure is then increased to assay the cracking pressure of at least one valve 100 on the die 530, as in more detail below.

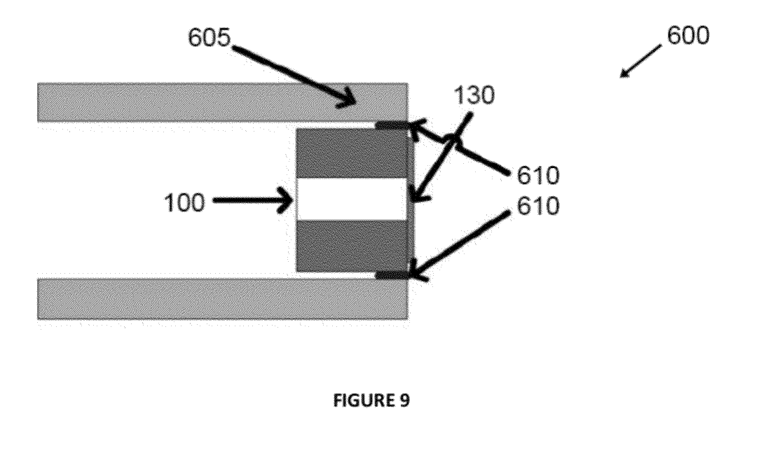

After a check valve 100 is separated from a die 530, a capillary tube testing adapter 600, as shown in FIG. 9, can be used to measure the cracking pressure thereof. Capillary tube 605 has a cross sectional dimension such as diameter selected to permit insertion of a valve 100 with sufficient relief space left over to permit the deposition of removable sealing material 610 into the relief space. The removable sealing material 610 is optionally photoresist material or another photosensitive material that creates a pressure-tight seal, but is removable by exposing the jig 600 to selected wavelengths of light. In use, a fluid such as air or water is introduced into the capillary tube 605 at a selected pressure, which pressure is increased to assay the cracking pressure of the valve 100, as discussed in more detail below.

To measure the cracking pressure of a valve or valves, a pressurized fluid is regulated and applied to the check valve through the backside holes, e.g. via the fluid supply 510 or the capillary tube 605, depending on the testing regime. The flow rate is recorded by measuring marching speed of the meniscus at the fluid front. When the valve is closed (i.e. the pressure applied is less than the cracking pressure of the valve), the marching speed is zero; the marching speed increases as the pressure applied reaches and exceeds the cracking pressure of the valve.

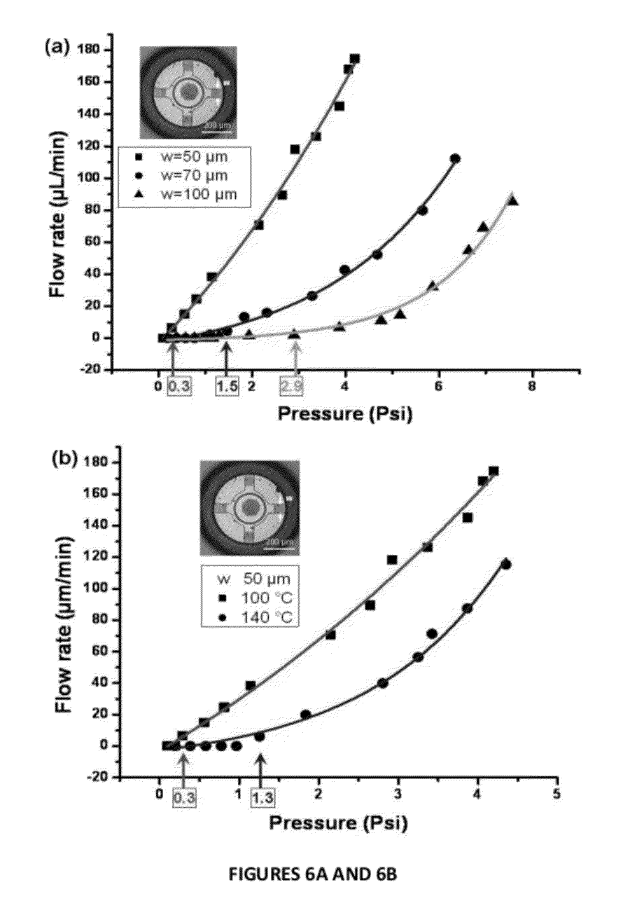

The measurement of cracking pressure according to embodiments of the invention, as well as other aspects of the invention, are illustrated by the following example: Valves annealed at 100° C. having three different tether widths (50 μm, 70 μm, 100 μm) were tested using testing setups of the invention. The cracking pressures were measured to be 0.3 PSI, 1.5 PSI, and 2.9 PSI respectively, as shown in FIG. 6A. The valve's cracking pressure increases as the width of the tethers 140 increases. Without wishing to be bound to any theory, the inventors believe this is because increased tether width results in increased pre-stressed force applied to the occluding portion 135. The flow profiles of two 50 μm-wide tether valves annealed differently at 100° C. and 140° C. were also compared, as shown in FIG. 6B. The cracking pressures were 0.3 PSI and 1.3 PSI, respectively. The increased cracking pressure is due to the increased thermal residual stress of parylene when the annealing temperature is increased.

The phrase “and/or,” as used herein should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The term “consists essentially of means excluding other materials that contribute to function, unless otherwise defined herein. Nonetheless, such other materials may be present, collectively or individually, in trace amounts.

As used in this specification, the term “substantially” or “approximately” means plus or minus 10% (e.g., by weight or by volume), and in some embodiments, plus or minus 5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

Certain embodiments of the present invention have described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A microfluidic check valve, comprising:
a base having an orifice therethrough; and
a sealing member comprising:
an occluding portion sized to occlude the orifice; and
at least one attachment member for urging the occluding portion into a closed position to occlude the orifice, wherein
(i) the occluding portion is moveable to an open position permitting fluid flow through the orifice in response to a fluid pressure on the occluding portion directed through the orifice, and (ii) the at least one attachment member consists essentially of a thermally annealed polymer.

2. The microfluidic check valve of claim 1, wherein the at least one attachment member is a plurality of tethers disposed radially about the occluding portion.

3. The microfluidic check valve of claim 1, wherein the at least one attachment member has a tensile stress between 700 and 2600 PSI.

4. The microfluidic check valve of claim 1, wherein the thermally annealed polymer has a Young's modulus of less than 5 GPa.

5. The microfluidic check valve of claim 4, wherein the thermally annealed polymer is thermally annealed parylene.

6. The microfluidic check valve of claim 1, wherein the at least one attachment member is angled away from the base.

7. The microfluidic check valve of claim 1, wherein the attachment member has a width of less than 100 μm.

8. The microfluidic check valve of claim 7, wherein the attachment member is characterized by a thickness of approximately 5 μm.

9. A method of forming a microfluidic check valve comprising the steps of:
providing a sealing member, comprising:
an occluding portion sized to occlude an orifice; and
at least one attachment member for urging the occluding portion into a closed position occluding the orifice; and
thermally annealing the at least one attachment member to increase a tensile stress of the at least one attachment member to at least 800 PSI.

10. The method of claim 9, wherein the sealing member includes parylene.

11. The method of claim 9, wherein the at least one attachment member is a plurality of tethers disposed radially about the occluding portion.

12. The method of claim 9, wherein the step of thermally annealing the at least one attachment member results in a tensile stress of between 1200 and 2600 MPa.

13. A method of forming a microfluidic check valve comprising the steps of:
providing a refractory base:
forming a generally frustoconical photoresist layer on the base;
applying a parylene coating to the base and the photoresist layer;
stripping the photoresist layer; and
thermally annealing at least a portion of the parylene coating to increase a tensile stress therewithin.

14. The microfluidic check valve of claim 13, wherein the step of forming a generally frustoconical photoresist layer includes developing the photoresist layer using a grayscale photomask, wherein the grayscale photomask has a non-linear UV light transmittance across a cross-sectional dimension of the grayscale photomask.
